(19) United States
(12) Patent Application Publication
(10) Pub. No.: US 2013/0332356 A1
(43) Pub. Date: Dec. 12, 2013

(54) MOBILE CARD MANAGEMENT METHOD

(71) Applicants: Kyung Yang Park, Seoul (KR); Hoon Joon Jung, Gunpo-si (KR)

(72) Inventors: Kyung Yang Park, Seoul (KR); Hoon Joon Jung, Gunpo-si (KR)

(73) Assignee: HAREX INFOTECH INC., Seoul (KR)

(21) Appl. No.: 14/001,543

(22) PCT Filed: Feb. 24, 2012
(86) PCT No.: PCT/KR2012/001440

§ 371 Date: Aug. 26, 2013

(30) Foreign Application Priority Data
Feb. 24, 2011 (KR) 10-2011-0016559

(51) Int. Cl. G06Q 20/36

(52) U.S. Cl. CPC G06Q 20/36
USPC 705/41

(57) ABSTRACT

In an embodiment of the present invention, there is disclosed a method of allowing a mobile payment program module to directly list up card information about a specific use (for example, payment, identification, membership, etc.) in the mobile communication terminal according to kinds of transaction characteristics and to select and use a desired card, instead of a method of delivering information (for example, service classification code information of AID code) determined by an external server to the mobile payment program module such that the mobile payment program module may find a corresponding card stored in the mobile communication terminal, among methods of selecting a specific card from among a plurality of cards stored in a mobile communication terminal.

### TECHNICAL FIELD

The present invention relates to a mobile card management method, and more particularly, to a mobile card management method capable of identifying various types of cards, for example, a payment card, an identity card, and a membership card, which are contained in a mobile communication terminal.

### BACKGROUND ART

In bank transaction and membership transaction, the use of a card with a mobile device is widely increasing. By storing a variety of card information such as a digital bankbook, account information, identification (ID) (a personal ID card, a student ID card, a pass, etc.) information, a transportation ticket, a ticket, a coupon, etc. in an IC chip card or memory of a mobile communication terminal and plugging in the to the IC chip card or memory to a cell phone, the cell phone instead of a bankbook or card may be used in payment or authentication service.

Recently, along with the development of the IC chip card, a memory of a chip card increases and thus a plurality of cards are issued for one chip card. The IC chip card having the issued plurality of cards is plugged in to a chip card socket of the mobile communication terminal and is issued as a mobile card in the form of combination of finance and mobile communication.

In design of the IC chip card or the memory of the mobile communication terminal for typical mobile payment, an application identifier (AID) code is used as an application program identifier, and in general, one independent AID code system is applied for each application. Specifically, a typical IC chip card has one AID and one applet for each service. That is, for example, a credit card, debit card, cash card, ID card, membership card, etc. have a credit applet, debit applet, cash applet, ID applet, membership applet, etc., respectively.

In order to execute a corresponding service in the ID chip or the memory of the mobile device, there should be one applet for each service because an AID code, which is given as an application protocol data unit (APDU) instruction in a mobile device for executing the chip card or memory, is delivered to the IC chip card, or the memory of the mobile communication terminal, a corresponding applet is selected, and the applet is made to be executable and then processed.

However, in order for a mobile terminal of a user to select and execute an applet corresponding to a service, the mobile terminal should perform a process of connecting to an external server providing the service and then reading out the AID code. That is, in a typical mobile transaction processing process, due to the process of reading out the AID code from the external server, only a specific card such as an EMV standard credit card is identified. Accordingly, when a user intends to use cards contained in the mobile terminal, the user can select and read out only one card. That is, the user cannot check which kind of cards his/her mobile terminal contains, without the help of the external server for searching or checking the AID code. In this case, the user also cannot check all cards available in the mobile terminal, which interrupts free card selection of the user.

### DISCLOSURE

### Technical Problem

The present invention provides an AID management method for mobile payment, which allows a user to check all cards contained in the mobile terminal of the user at a glance and by types in a mobile card management process.

### Technical Solution

To achieve these and other advantages and in accordance with the purpose of the present invention as embodied and broadly described herein, a mobile card management method in accordance with an aspect of the present invention includes: receiving, by a mobile communication terminal of a user, a plurality of pieces of application identifier (AID) information corresponding to a plurality of pieces of card information issued from an external server; separately storing, by the mobile communication terminal, the plurality of pieces of card information and the plurality of pieces of AID information in a built-in memory included in the mobile communication terminal; searching, by a mobile card management program module installed in the mobile communication terminal, all cards corresponding to the plurality of pieces of AID information with reference to the plurality of pieces of AID information stored in the memory, and listing up the searched all cards to display the listed-up all cards through a display module included in the mobile communication terminal; and selecting, by the mobile communication terminal, any one of the displayed all cards according to an operation of the user to provide a mobile service corresponding to the selected card.

### Advantageous Effects

According to the present invention, a mobile payment program installed in the mobile device of the user can read out and list up all cards available for payment with the mobile device, and thus a user can select a specific card from among all the cards according to the user's intention, thereby providing a user convenience during a mobile payment processing process.

### DESCRIPTION OF DRAWINGS

FIG. 1 is a block diagram of an entire service system using a mobile communication terminal having an IC chip card or memory which supports multiple card issuers according to an embodiment of the present invention.

FIG. 2 is a flowchart illustrating a process of issuing a plurality of cards in the service system of the FIG. 1.

FIG. 3 is a flowchart illustrating a process of showing a user all cards contained in the mobile communication terminal shown in FIG. 1, without an inquiry to an external server.

### BEST MODE

In an embodiment of the present invention, there is disclosed a method of allowing a mobile card management program module to directly list up card information about a specific use (for example, payment, identification, membership, etc.) in the mobile communication terminal according to kinds of transaction characteristics and to select and use a desired card, instead of a method of delivering information (for example, service classification code information of AID code) determined by an external server to the mobile card management program module such that the mobile card management program module may find a corresponding card stored in the mobile communication terminal, among methods of selecting a specific card from among a plurality of cards stored in a mobile communication terminal.

Embodiments of the present invention will be described below in more detail with reference to the accompanying drawings.

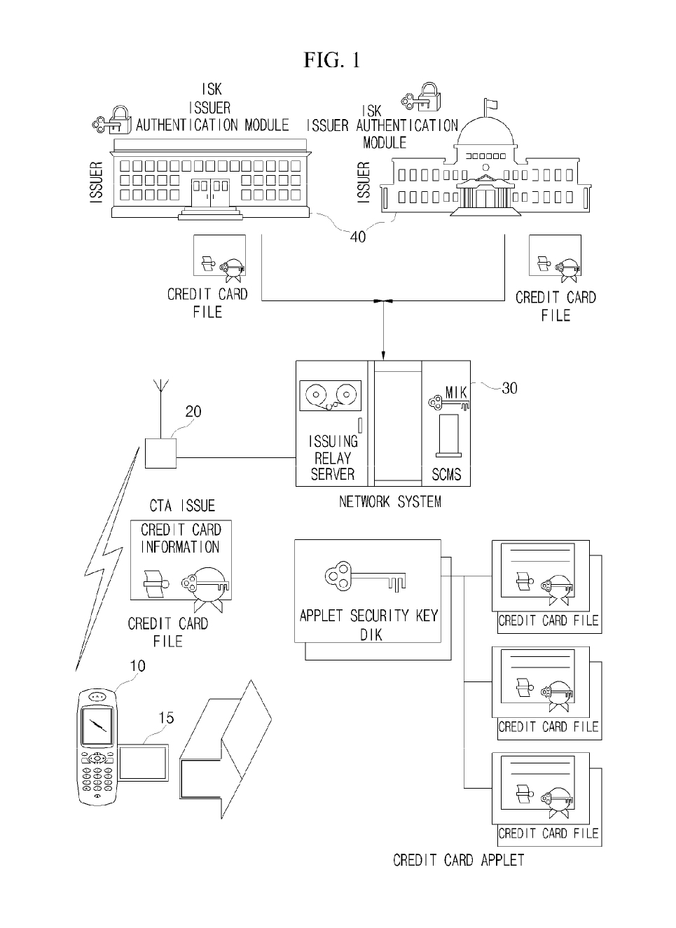

FIG. 1 is a block diagram of an entire service system using a mobile communication terminal having an IC chip card or memory which supports multiple card issuers according to an embodiment of the present invention.

Referring to FIG. 1, the service system has an IC chip card 15 storing a plurality of cards issued by multiple card issuers and a mobile communication terminal 10 including a smartphone having an IC chip card plugged in to a socket such that the smartphone may be used as a mobile card.

In an embodiment of the present invention as shown in FIG. 1, an example is illustrated in which the plurality of cards are issued and stored in the IC chip card 15. However, the plurality of cards may be issued and stored in a built-in memory included in the mobile communication terminal 10 instead of a chip-type card.

The service system further includes a mobile communication company system 20 for authenticating whether a mobile communication terminal of a card issuing applicant is available to use a mobile card, a network center 30 for OTA(Over The Air)-issuing card information to the IC card 15 plugged in to the mobile communication terminal 10 over wireless connection with the mobile communication terminal 10, and multiple card issuers 40. The network center 30 may be provided with an issuing relay server for OTA-issuing the IC chip card 15 and a smart card management system (SCMS) for managing a history and related services of the issued IC chip card 15. Here, the network center 30 may be directly operated by the card company 40.

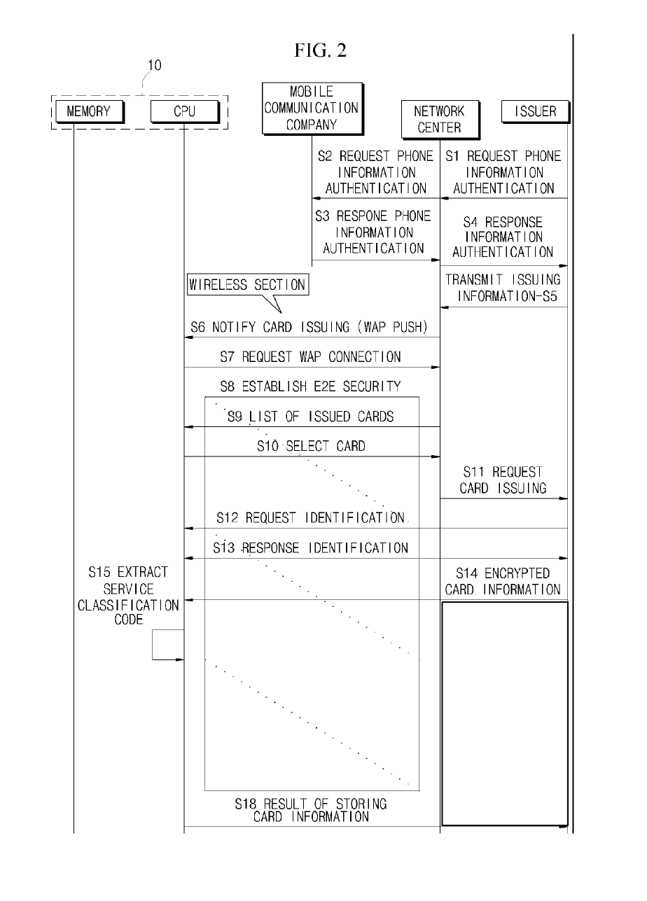

Detail operations for supporting multiple card issuers in the service system of FIG. 1 will be descried with reference to FIG. 2.

FIG. 2 is a flowchart illustrating a process of issuing a plurality of cards in the service system of the FIG. 1.

Referring to FIG. 2, the card issuer 40 of FIG. 1 requests the network center to authenticate whether a card issuing applicant (hereinafter, also referred to as client or subscriber) can plug in a mobile card, or have a mobile communication terminal available for mobile payment in operation S1.

In the authentication, the phone number, resident registration number, and name of the subscriber may be used.

The network center 30 relays information (the phone number, resident registration number, and name of the subscriber of the mobile communication terminal) about the mobile communication terminal of the card issuing applicant to the mobile communication company system 20 in operation S2.

The mobile communication company system 20 performs authentication (mobile phone or applicant) using its own database and transmits a result of the authentication to the network center 30 in operation S3.

The network center 30 transmits the authentication result to the card issuer 40 that has requested the authentication in operation S4.

The card issuer 40 forms card issuing information for the applicant who has passed the authentication and transmits the formed card issuing information to the network center 30 in operation S5.

The network center 30 forms card issuing notification message (including a card name) and transmits the card issuing notification message to the mobile communication terminal 10 of the client over a mobile communication network (for example, SMS) in operation S6.

When the user checks a message stored in the mobile communication terminal 10, the user requests the network center 30 to allow wireless internet connection using a call back URL in operation S7.

E2E security is established between the mobile communication terminal 10 of the user and the network center 30 in operation S8.

The network center 30 forms a list of the issued cards, and transmits the list to the mobile communication terminal 10 of the user over a pre-established communication channel in operation S9.

The user checks the list and selects a card, which the user desires to issue, from among the list through a key operation of the mobile communication terminal 10 in operation S10. The network center 30 requests the card issuer 40 to issue the card selected by the user in operation S11, and the card issuer 40 requires an authentication value in order to identify the card issuing applicant in operation S12. In the identification, an authentication procedure (last 7 digits of resident registration number or card payment password) designated by the card issuer 40 may be used, or may be omitted depending on the card issuer 40.

When the card issuer 40 requires the authentication procedure, the user transmits an authentication value required by the card issuer 40 to the card issuer 40 by inputting the authentication value into the mobile communication terminal 10 in operation S13.

The card issuer 40 issues card information when the identification is correct, and then transmits card information encrypted by an encryption module installed in the card issuer 40 to the mobile communication terminal 10 of the client over a pre-established communication channel in operation S14. Here, the encrypted card information includes encrypted AID code information, and the encrypted AID code information includes registered application provider identifier (RID) code information and proprietary application identifier extension (PIX) code information. The RID code information may be subdivided into registration code information, nation code information, industry classification code information, institution code information, and work code information, and the PIX code information is used as service classification code information (for example, credit, debit, cash, check, ID, etc.). In an embodiment of the present invention, an example is described in which the AID code information is included in the encrypted card information and transmitted to the mobile communication terminal. However, the present invention is not limited thereto. That is, the AID code information may be transmitted to the mobile communication terminal independently of the encrypted card information in packet units.

The mobile communication terminal 10 extracts only service classification code information from the transmitted encrypted card information in operation S15, and transmits the transmitted encrypted card information to the IC chip card, or the built-in memory 15 included in the mobile communication terminal in operation S16. In this case, the extracted service classification code information is delivered to the ID chip card, or the built-in memory 15 included in the mobile communication terminal, and separately stored in a specific region provided in the ID chip card, or the built-in memory 15 included in the mobile communication terminal. That is, the ID chip card, or the built-in memory 15 of the mobile communication terminal is physically or logically divided into a first storage region and a second storage region. The card information is stored and managed in the first storage region, and the service classification code information included in the card information is stored and managed in the second storage region.

As such, the mobile communication terminal of the present invention has a separate storage region where the service classification code information corresponding to each of a plurality of cards is stored. Thus, without the inquiry to an external server such as an issuer, a list of the plurality of cards may be identified and managed.

Then, the IC chip card 15 or the built-in memory included in the mobile communication terminal stores the encrypted card information, stores the service classification code information extracted from the encrypted card information in another storage region which is separate from a storage region where the encrypted card information is stored, and delivers a result value to the mobile communication terminal 10 in operation S16. The mobile communication terminal 10 delivers the result value to the card issuer 40 over a pre-established communication channel in operation S17.

As such, in operation S18, the present invention stores only the service classification code information for identifying a specific card in a specific storage region provided in a memory embedded in the IC chip or a built-in memory included in the mobile communication terminal, in a process of issuing and storing a plurality of cards in the IC chip card 15 or the built-in memory of the mobile communication terminal. Then, the stored service classification code information is listed up to be checked at a glance according to a user request.

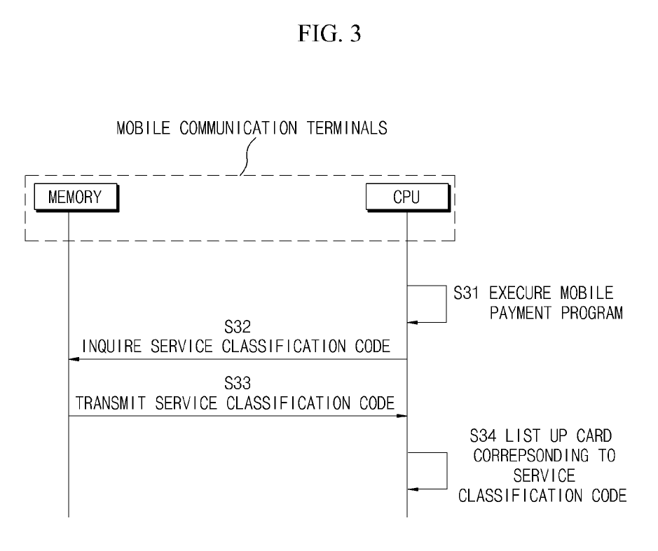

FIG. 3 is a flowchart illustrating a process of showing a user all cards contained in the mobile communication terminal shown in FIG. 1, without an inquiry to an external server.

Referring to FIG. 3, when a user visits a specific shopping mall for product purchase to select a product to be purchased, the control unit (for example, central processing unit) of the mobile communication terminal of the user executes a mobile card management program module previously received through a communication medium according to an operation of the user in operation S31.

The executed mobile payment program module inquires service classification code information separately stored in a specific storage region of the IC chip card such as USIM chip or the built-in memory included in the mobile communication terminal in operation S32.

Next, the mobile card management program module reads all service classification code information in operation S33, and lists up all cards available by a user through a display module included in the mobile communication terminal such that the user may check all the cards at a glance in operation S34. Then, the user selects a card used for payment from among the listed-up cards to perform the payment.

As described above, instead of inquiring the external server of the AID code to check which kinds of cards the mobile communication terminal contains, the mobile communication terminal may store the AID code information therein, inquire the AID code information stored therein, and list up card information about a plurality of cards contained in the mobile communication terminal such that the user may check the information at a glance, thereby checking at a glance all the cards for payment contained in the mobile device and enhancing mobile payment convenience.

1. A mobile card management method comprising:
receiving, by a mobile communication terminal of a user, a plurality of pieces of application identifier (AID) information corresponding to a plurality of pieces of card information issued from an external server;
separately storing, by the mobile communication terminal, the plurality of pieces of card information and the plurality of pieces of AID information in a memory included in the mobile communication terminal;
searching, by a mobile card management program module installed in the mobile communication terminal, all cards corresponding to the plurality of pieces of AID information with reference to the plurality of pieces of AID information stored in the memory, and listing up the searched all cards to display the listed-up all cards through a display module included in the mobile communication terminal; and
selecting, by the mobile communication terminal, any one of the displayed all cards according to an operation of the user to provide a mobile service corresponding to the selected card.

2. The mobile card management method of claim 1, wherein the storing of the plurality of pieces of card information and the plurality of pieces of AID information in a memory comprises:
physically or logically dividing, by the mobile communication terminal, the memory into the first storage region and the second storage region; and
storing, by the mobile communication terminal, the plurality of pieces of card information in the first storage region and storing the plurality of pieces of AID information in the second storage region.

3. The mobile card management method of claim 2, wherein the plurality of pieces of AID information each comprise registered application provider identifier (RID) code information and proprietary application identifier extension (PIX) code information (hereinafter, referred to as service classification code information), and wherein the service classification code information is stored in the second storage region.

4. The mobile card management method of claim 1, wherein the memory is an IC chip plugged in to the mobile communication terminal or a memory included in the mobile communication terminal.
